(19) United States
(12) Patent Application Publication
(10) Pub. No.: US 2026/0358196 A1
(43) Pub. Date: Nov. 12, 2026

(54) MONITORING SYSTEM FOR A HYDRODYNAMIC BEARING

(71) Applicant: Caterpillar Inc., Peoria, IL (US)

(72) Inventors: Christopher Michael Gruel, Edwards, IL (US); Mathew David Guldan, Metamora, IL (US); Matthew D Nagode, Wyoming, IL (US); Benjamin Thomas Nelson, Dunlap, IL (US); Jose Quiroz, Peoria, IL (US); Thomas Maier, Elmwood, IL (US); John Clifford, Henry, IL (US); Dustin Harris, Minier, IL (US)

(73) Assignee: Caterpillar Inc., Peoria, IL (US)

(21) Appl. No.: 19/205,302

(22) Filed: May 12, 2025

(51) Int. Cl. G01M 13/04; E02F 9/22; E02F 9/26

(52) U.S. Cl. CPC G01M 13/04; E02F 9/2221; E02F 9/2246; E02F 9/2264; E02F 9/268

(57) ABSTRACT

A monitoring system may include a sensor configured to measure, via a measurement passage, a property of fluid used in a hydrodynamic bearing disposed in a housing. The sensor may be coupled to a measurement port accessible from an exterior of the housing, and the measurement passage fluidly may connect a bearing liner of the hydrodynamic bearing and the measurement port. The monitoring system may include a controller configured to receive, from the sensor, sensor data indicating a measurement of the property, determine a difference between the measurement and a baseline value for the property, determine whether the difference satisfies a threshold, and output an indication that the hydrodynamic bearing is faulty based on determining that the difference satisfies the threshold.

### TECHNICAL FIELD

The present disclosure relates generally to work machines and, for example, to a monitoring system for a hydrodynamic bearing of work machines.

### BACKGROUND

Hydrodynamic bearings are used in various industrial and mechanical applications due to their ability to support high loads while minimizing friction and wear. These bearings often rely on a thin film of fluid to separate the rotating journal from the bearing surface, preventing direct contact between components. However, despite their advantages, hydrodynamic bearings present significant challenges in terms of monitoring their health and detecting potential failures.

One challenge is that hydrodynamic bearings are often located in areas that are difficult to access, making routine inspections and maintenance cumbersome and expensive. Over time, factors such as lubricant degradation, contamination, and operational stresses can cause the bearing to wear. If the fluid film is compromised, the rotating journal may come into direct contact with the bearing surface, initiating wear and increasing the clearance between components. This degradation can lead to reduced load-bearing capacity, inefficiencies in the machinery, and ultimately, mechanical failure.

Undetected bearing wear can have cascading effects on the overall system. As wear progresses, the reduction in fluid film pressure can serve as an early indicator of potential failure. If left unaddressed, further degradation may lead to catastrophic failure, where the bearing locks onto the rotating journal, causing severe damage. In such cases, the bearing may begin rotating relative to its housing, generating additional wear and potentially disconnecting the fluid pressure measurement from the bearing’s lubrication system.

The inability to detect early signs of bearing failure increases repair costs and leads to unplanned downtime, negatively impacting productivity. Without proper monitoring, a failed bearing may place excessive loads on surrounding components, accelerating wear and causing secondary failures.

The monitoring system of the present disclosure solves one or more of the problems set forth above and/or other problems in the art.

### SUMMARY

A monitoring system may include a sensor configured to measure, via a measurement passage, a property of fluid used in a hydrodynamic bearing disposed in a housing. The sensor may be coupled to a measurement port accessible from an exterior of the housing, and the measurement passage fluidly may connect a bearing liner of the hydrodynamic bearing and the measurement port. The monitoring system may include a controller configured to receive, from the sensor, sensor data indicating a measurement of the property. The controller may be configured to determine a difference between the measurement and a baseline value for the property. The controller may be configured to determine whether the difference satisfies a threshold. The controller may be configured to output an indication that the hydrodynamic bearing is faulty based on determining that the difference satisfies the threshold.

A method may include receiving, by a controller, sensor data indicating a measurement for a property of fluid used in a hydrodynamic bearing of a machine. The property may be a temperature or a pressure of the fluid. The method may include determining a difference between the measurement and a baseline value for the property. The method may include determining whether the difference satisfies a threshold indicative of faultiness of the hydrodynamic bearing. The method may include causing adjustment to one or more operating parameters of the machine based on determining that the difference satisfies the threshold.

A work machine may include a prime mover and a gear train. The gear train may include a housing, a rotatable journal, disposed in the housing, operatively coupled to the prime mover, a hydrodynamic bearing including a bearing liner between the housing and the rotatable journal, and a measurement port, accessible from an exterior of the housing, that is fluidly connected to the bearing liner via a measurement passage that extends through the housing, and a monitoring system. The monitoring system may include a sensor, coupled to the measurement port, configured to measure, via the measurement passage, a property of fluid used in the hydrodynamic bearing. The monitoring system may include a controller. The controller may receive, from the sensor, sensor data indicating a measurement of the property. The controller may determine a difference between the measurement and a baseline value for the property. The controller may output an indication that the hydrodynamic bearing is faulty based on determining that the difference satisfies a threshold.

### BRIEF DESCRIPTION OF THE DRAWINGS

FIG. 1 is a side view of an example machine.

FIG. 2 is a partial cross-sectional, front view of an example of a gear train in the machine of FIG. 1.

FIG. 3 is a front view of an example of a portion of the gear train of FIG. 2.

FIG. 4 is a cross-sectional, side view of an example of a portion of the gear train of FIG. 2.

FIG. 5 is a front view of an example of a portion of the gear train of FIG. 2.

FIG. 6 is a flowchart of an example method.

### DETAILED DESCRIPTION

This disclosure relates to a monitoring system, which is applicable to any machine that includes a hydrodynamic bearing, such as in a gear train for a hydraulic pump. For example, the machine may be an excavator, a motor grader, a backhoe loader, a wheel loader, a skid steer loader, a dozer, or other vehicles or machines that include a gear train and/or a hydrodynamic bearing.

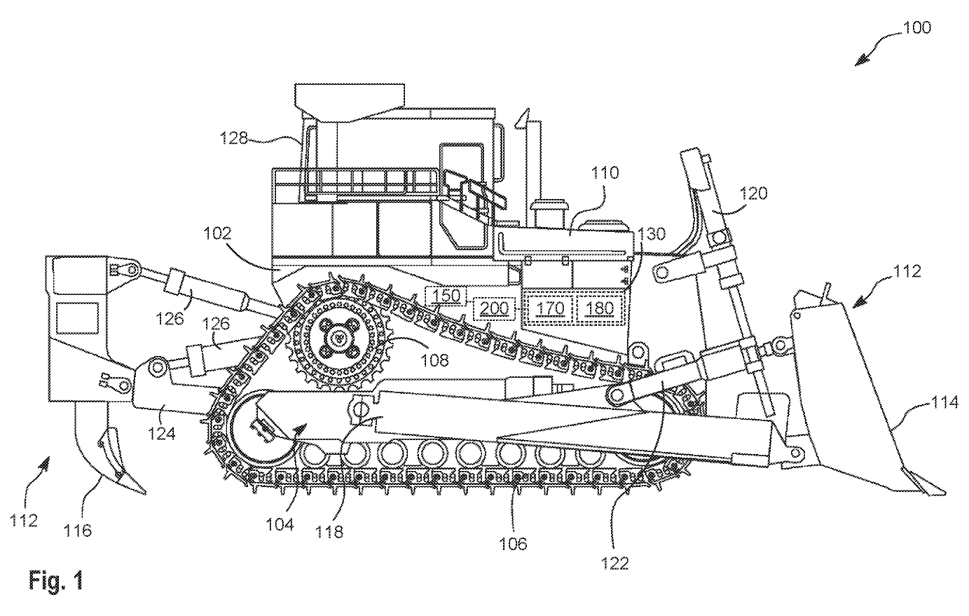

FIG. 1 is a side view of an example machine 100 (e.g., a work machine). The machine 100 may perform earth moving or another operation associated with an industry such as construction or mining, among other examples. For example, as illustrated in FIG. 1, the machine 100 is a dozer. However, the machine 100 may be another type of machine, as described above.

The machine 100 includes a frame 102 that is supported by an undercarriage 104 used to propel the machine 100 in a forward direction and/or a rearward direction. The undercarriage 104 is configured to engage a ground surface, such as a road or another type of terrain. The undercarriage 104 includes a pair of tracks 106 (only one track 106 is visible in FIG. 1) driven by respective drive wheels 108. Although the machine 100 is illustrated as having tracks 106, the undercarriage 104 may additionally, or alternatively, include one or more wheels for propelling the machine 100.

The frame 102 supports one or more hydraulic pumps 150, such as a centrifugal pump, a gear pump, a piston pump, or the like. The hydraulic pump 150 may pressurize fluid for powering a steering system, an implement system, a powertrain system, a thermal regulation system, or another system of the machine 100. The frame 102 supports a prime mover 110. The prime mover 110 may include an engine (e.g., an internal combustion engine), such as a diesel engine, a gasoline engine, or a gaseous fuel engine, among other examples. Additionally, or alternatively, the prime mover 110 may include an electric motor (e.g., for electric powering of machine 100 or hybrid powering of machine 100 with the engine). The prime mover 110 is configured to provide power to various components of the machine 100 via a gear train 200. For example, the prime mover 110 is configured to drive the tracks 106 via the gear train 200. In some examples, the prime mover 110 is configured to provide power to the hydraulic pump 150 via the gear train 200. For example, the prime mover 110 may power one or more implements 112 via the gear train 200, by providing power to the hydraulic pump 150.

In FIG. 1, the implements 112 are illustrated as a blade 114, attached to a front of the machine 100, and a ripper 116 attached to a rear of the machine 100. However, the implement 112 may be, for example, a bucket, a scoop, a moldboard, a hook, and/or a backhoe, among other examples. The implements 112 are movable with respect to the frame 102. For example, the blade 114 may be pivotally connected to the frame 102 by arms 118 on each side of the machine 100. One or more first hydraulic cylinders 120 may be coupled to the frame 102 to support the blade 114 in the vertical direction and allow the blade 114 to move up or down vertically. Additionally, one or more second hydraulic cylinders 122 may be included on each side of the machine 100 to allow a pitch or an angle of the blade 114 to change. The first and second hydraulic cylinders 120, 122 may be actuators that receive actuation instructions to adjust, lift, lower, or otherwise move and/or position the blade 114. Similarly, the ripper 116 may be pivotally connected to the frame 102 by one or more arms 124, and one or more hydraulic cylinders 126 may be coupled to the frame 102 to support the ripper 116 and allow the ripper 116 to move up or down vertically.

An operator station 128 may be supported on the frame 102. The operator station 128 may include an operator console having one or more displays (e.g., touchscreen displays) and/or one or more operator controls to operate and/or drive the machine 100. For example, the operator controls may include a joystick, a lever, and/or a knob, among other examples.

As described herein, the machine 100 includes a monitoring system 130 configured to determine a property (e.g., a pressure, a temperature, etc.) of fluid used in the gear train 200 of the machine 100 (e.g., for the hydraulic pump 150). The monitoring system 130 includes a sensor 170 and a controller 180. The sensor 170 may measure a property of fluid used in the gear train 200 of the machine 100 (e.g., for the hydraulic pump 150). The controller 180 may electrically control and/or monitor various aspects of the gear train 200 and/or the machine 100. For example, the controller 180 may be a pump controller of the hydraulic pump 150, a gear controller of the gear train 200, or may be a machine-level controller of the machine 100. The controller 180 may send and receive signals from the hydraulic pump 150 and/or the gear train 200 during the operation of the machine 100.

As indicated above, FIG. 1 is provided as an example. Other examples may differ from what is described with regard to FIG. 1.

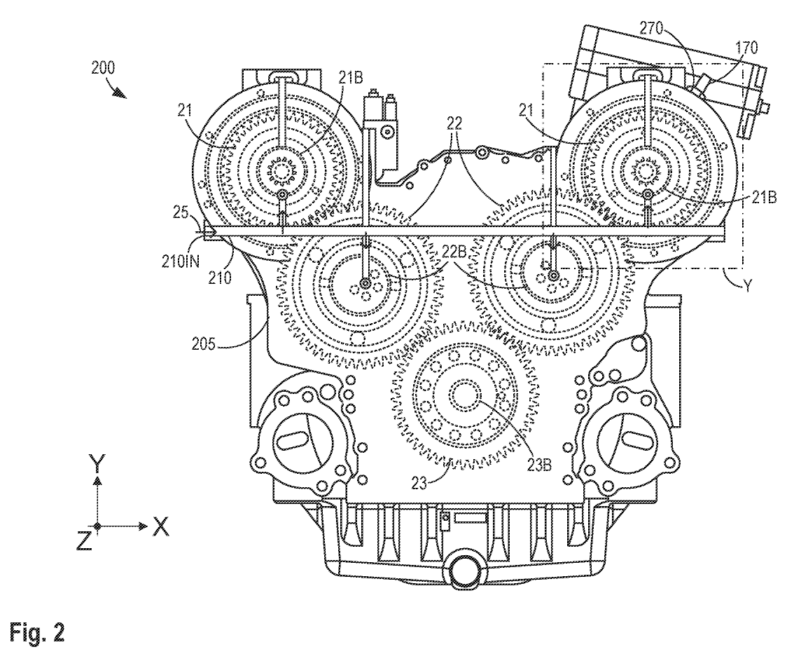

FIG. 2 is a partial cross-sectional, front view of an example of the gear train 200 in the machine 100. The gear train 200 may include a housing 205, drive gears 21, idler drive gears 22, an input gear 23, and a fluid supply passage 210. The drive gears 21, the idler drive gears 22, and the input gear 23 may include bearings 21B, 22B, and 23B, respectively. Thus, the bearings 21B, 22B, and 23B are disposed in the housing 205 of the gear train 200. In some examples, the bearings 21B, 22B, and 23B may be hydrodynamic bearings. As a non-limiting example, the gear train 200 is shown as an engine rear gear train (e.g., of an engine rear drive system for the hydraulic pump 150, the prime mover 110, etc.). However, the gear train 200 may be of any component of the machine 100. For example, the gear train 200 may be of a gear pump, a transmission system, an engine/motor drive system, an axles drive system, etc.

The drive gears 21 may be operatively coupled to operating components (not shown in FIG. 2) for operations of the machine 100. For example, the drive gears 21 are operatively coupled with the implements 112. The input gear 23 may be operatively coupled to a power source (e.g., the prime mover 110, a crankshaft connected thereto, etc.). The input gear 23 may provide a power to operate the idler drive gears 22 and the drive gears 21, thereby operating, for example, the hydraulic pump 150. The fluid supply passage 210 may be located in the housing 205. The fluid supply passage 210 may be fluidly coupled with at least one of the bearings 21B and 22B. The fluid supply passage 210 may receive fluid 25 (e.g., lubricant fluid) through a fluid supply input 210IN and supply the fluid 25 (e.g., lubricant fluid) to one or more of the bearings 21B and 22B. In some examples, as shown, the fluid supply passage 210 may receive the fluid 25 in the X-direction, and then provide the fluid 25 to the one or more of the bearings 21B and 22B, vertically in the Z-direction. In some examples, the fluid supply passage 210 may include a passage fluidly connected to the bearing 23B and supply the fluid 25 thereto.

The monitoring system 130 is communicatively coupled to the gear train 200 to monitor the fluid 25 and/or the gear train 200. For example, the sensor 170 may be coupled to a measurement port 270 accessible from an exterior of the housing 205. While in FIG. 2, the sensor 170 and the measurement port 270 are shown to be located adjacent to the bearing 21B, the sensor 170 and the measurement port 270 may be located in various locations of the housing 205. For example, the sensor 170 and the measurement port 270 may be located adjacent to one or more of the bearings 21B, 22B, and 23B. In some implementations, the sensor 170 and the measurement port 270 may be located at one of the bearings 21B, 22B, and 23B, based on characteristics (e.g., locations, loads, sizes, bearing material, etc.) of the bearings 21B, 22B, and 23B. In some examples, the sensor 170 and the measurement port 270 may be located at a last one of the bearings (e.g., the bearing 21B as shown in FIG. 2) that is located furthest from the fluid supply input 210IN. Positioning the sensor 170 and the measurement port 270 at the last bearing (e.g., the bearing 21B) allows for detection of failures occurring along the fluid supply path or at upstream bearings (e.g., the bearings 22B and 23B), since such failures may cause changes in fluid pressure and/or temperature that become detectable at the final measurement point. In some other examples, the sensor 170 and the measurement port 270 may be located at one of the bearings that is the most highly loaded and/or most likely to fail. In some implementations, the sensor 170 and the measurement port 270 may be located based on risk metrics of the bearings 21B, 22B, and 23B. For example, the risk metrics may include the risk (e.g., probability, frequency, etc.) of each of the bearings 21B, 22B, and 23B, and the sensor 170 and the measurement port 270 may be located at one of the bearings 21B, 22B, and 23B whose risk metric indicates a highest probability of failure. As discussed below in greater details, the monitoring system 130 may measure, monitor, or otherwise determine a property (e.g., a pressure, a temperature, etc.) of the fluid 25 used in one or more of the bearings 21B, 22B, and 23B.

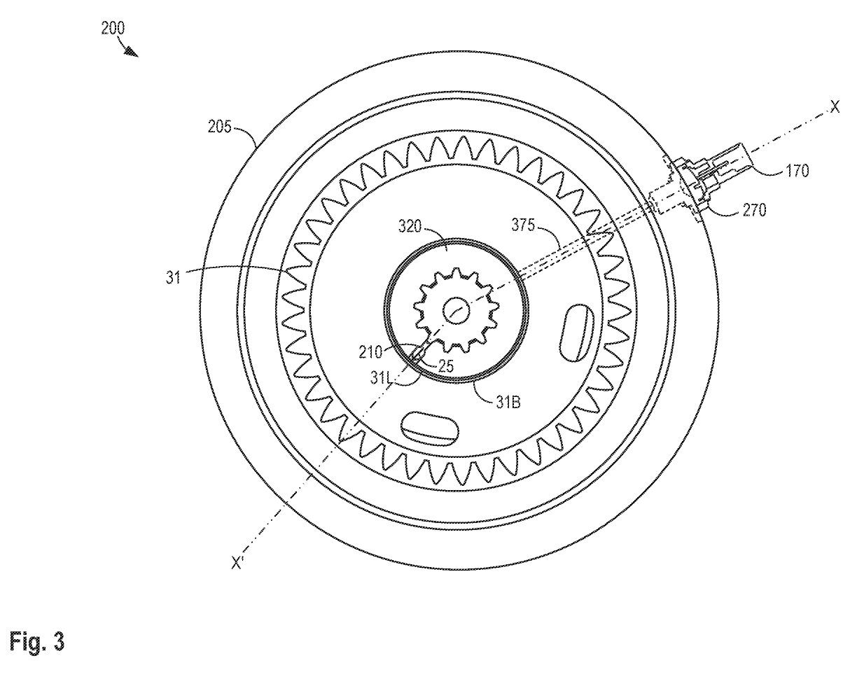

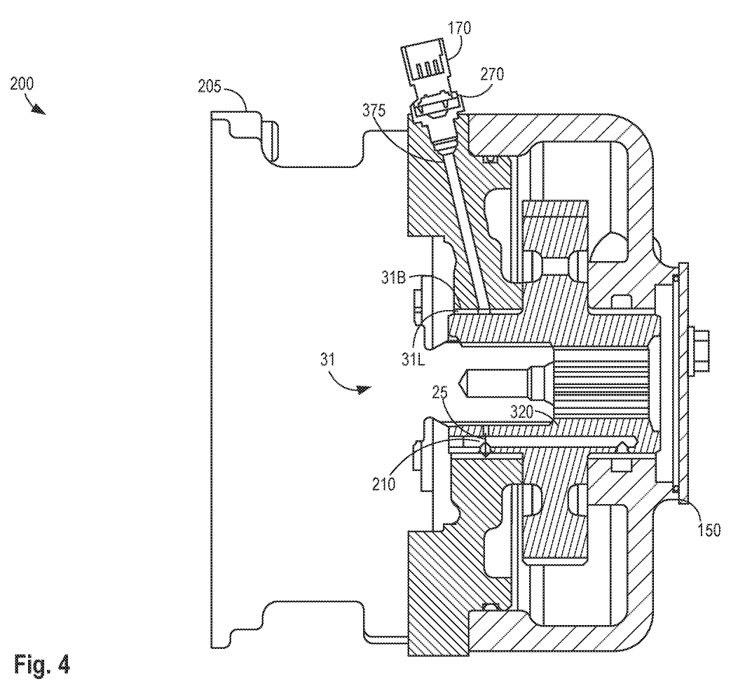

FIG. 3 is a front view of an example of a portion of the gear train 200. More specifically, shown in FIG. 3 is a gear 31 disposed in the housing 205. FIG. 4 is a cross-sectional, side view (e.g., perpendicular to the view shown in FIG. 3, along the line X-X') of an example of a portion of the gear train 200. In FIG. 4, the gear 31 is shown as being connected to the hydraulic pump 150 as a non-limiting example. The gear train 200 may include a rotatable journal 320 and a bearing 31B. The housing 205 may include a measurement passage 375.

The gear 31 shown in FIGS. 3 and 4 may be any of the drive gears 21, the idler drive gears 22, and the input gear 23 shown in FIG. 2. For example, FIG. 3 may be a detailed view of the portion Y of the gear train 200 shown in FIG. 2, and FIG. 4 may be a cross-sectional view of the portion Y of the gear train 200 shown in FIG. 2. However, the measurement port 270, the sensor 170, and/or the measurement passage 375 may be located at any of the drive gears 21, the idler drive gears 22, and the input gear 23 shown in FIG. 2. For example, the measurement port 270, the sensor 170, and/or the measurement passage 375 may be located at the drive gears 21 to monitor fluid in the drive gears 21. The measurement port 270, the sensor 170, and/or the measurement passage 375 may be located at the idler drive gears 22 to monitor fluid in the idler drive gears 22. The measurement port 270, the sensor 170, and/or the measurement passage 375 may be located at the input gear 23 to monitor fluid in the input gear 23.

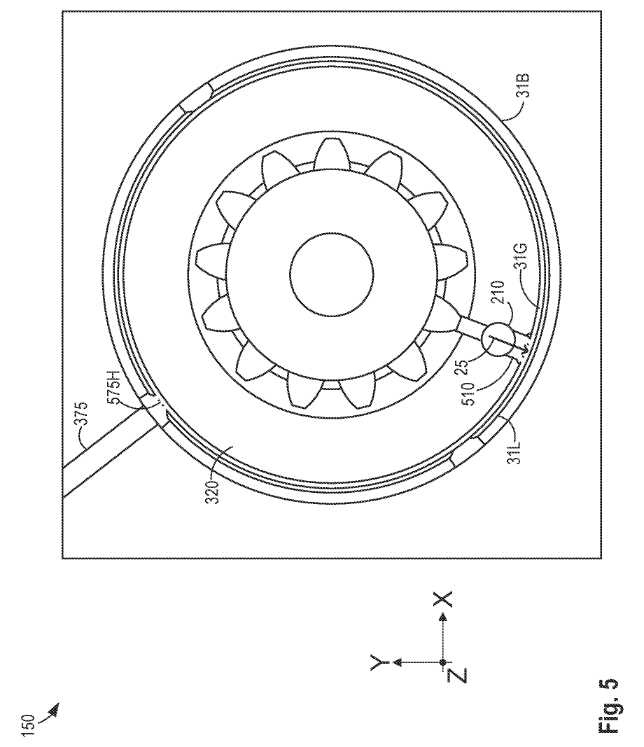

The rotatable journal 320 may be disposed in the housing 205 and operatively coupled to the prime mover 110. The bearing 31B may include a bearing liner 31L between the housing 205 and the rotatable journal 320. The bearing liner 31L may provide a fluid path where the fluid 25 can flow between the rotatable journal 320 and a surface of the bearing liner 31L to prevent a direct contact therebetween. The fluid supply passage 210 may be fluidly connected to the bearing liner 31L and supply the fluid 25 thereto. The fluid 25 may be fed, through the fluid supply passage 210, into the bearing liner 31L. In some examples, the bearing 31B may include the fluid 25 contained therein. The measurement passage 375 may fluidly connect the bearing liner 31L of the bearing 31B with the measurement port 270 (and/or the sensor 170). For example, the measurement passage 375 may extend through the housing 205, fluidly connecting the measurement port 270 and the bearing liner 31L. In some examples, the bearing liner 31L may define a hole that connects the measurement port 270 to an inner circumference of the bearing liner 31L via the measurement passage 375 (e.g., as shown in FIG. 5).

The sensor 170 may measure a property of the fluid 25 used in the bearing 31B. For example, the sensor 170 may measure a pressure of the fluid 25, a temperature of the fluid 25, or other physical and/or chemical properties of the fluid 25. The property of the fluid 25, such as temperature or pressure, may provide a proxy for a level of wear or faultiness of the bearing 31B. For example, as wear of the bearing liner 31L progresses, increased clearances in the bearing liner 31L may lead to a reduction in the sensed pressure. In cases of catastrophic failure, the bearing liner 31L may lock to the rotatable journal 320, causing relative motion between the bearing liner 31L and the housing 205. This can result in wear at the bearing-housing interface, creating a gap that disrupts the fluid connection between the measurement passage 375 and the bearing liner 31L. Consequently, the measured pressure may experience a sudden and significant change. Similarly, temperature variations can indicate different stages of bearing degradation. For example, a gradual temperature increase may result from increased friction due to wear, while a sharp rise may signal impending failure, such as a metal-to-metal contact. Moreover, changes in temperature may be proportional to changes in pressure, such that temperature changes can provide the same information as pressure changes, described herein.

The sensor 170 may measure the property of the fluid 25 via the measurement passage 375. For example, the fluid 25 in the bearing 31B may flow into the measurement passage 375 where it can be measured by the sensor 170. In some examples, the sensor 170 may be coupled to the measurement port 270, which fluidly connects the sensor 170 with the bearing liner 31L. In some examples, the sensor 170 may include a temperature probe extending into the measurement passage 375. The temperature probe may sense the temperature of the fluid 25 in the bearing liner 31L.

FIG. 5 is a front view of an example of a portion of the gear train 200. More specifically, shown is a portion of the bearing 31B of FIG. 3 fluidly connected to the measurement passage 375. The bearing liner 31L may include an annular groove 31G. The annular groove 31G may extend around an inner circumference of the bearing liner 31L. The annular groove 31G may be in fluid communication with the fluid supply passage 210. The fluid 25 may flow through the fluid supply passage 210 into the annular groove 31G. For example, the fluid supply passage 210 may direct the fluid 25 away from the page (e.g., in the Z-direction) to a fluid connection 510, which may direct the fluid 25 to the annular groove 31G (e.g., an inner circumference of the bearing liner 31L). The fluid 25 may travel around the inner circumference of the bearing liner 31L in the annular groove 31G between the bearing liner 31L and the rotatable journal 320. Thus, the fluid 25 and the bearing liner 31L may together define the bearing 31B. The bearing liner 31L may include a hole 575H that extends through the bearing liner 31L. The hole 575H may provide fluid coupling between the measurement passage 375 and the annular groove 31G (e.g., an inner circumference of the bearing liner 31L), to allow the fluid 25 flowing in the annular groove 31G to flow into the measurement passage 375 for measurement by the sensor 170. In some examples, the measurement passage 375 extends along the XY plane. In some other examples, the measurement passage 375 may be inclined at an angle (e.g., an acute angle) with respect to the XY plane. Accordingly, the fluid supply passage 210 is independent of the measurement passage 375 (e.g., the fluid supply passage 210 and the measurement passage 375 do not intersect). Moreover, as described herein, the fluid supply passage 210 and the measurement passage 375 are oriented on orthogonal axes. For example, the measurement passage 375 may be in plane with the bearing 31B, whereas the fluid supply passage 210 may be out of plane with the bearing 31B. As an example, the fluid supply passage 210 may be aligned with rotation axis of the bearing 31B, and the measurement passage 375 may be orthogonal to the rotation axis of the bearing 31B.

As disclosed herein, the controller 180 of the monitoring system 130 can receive data (e.g., measurements) from the sensor 170, process the data, and perform various operations. For example, the controller 180 may electrically control and/or monitor various aspects of the gear train 200 and/or the machine 100.

The controller 180 may include one or more memories and one or more processors communicatively coupled to the one or more memories. A processor may include a central processing unit, a graphics processing unit, a microprocessor, a controller, a microcontroller, a digital signal processor, a field-programmable gate array, an application-specific integrated circuit, and/or another type of processing component. The processor may be implemented in hardware, firmware, or a combination of hardware and software. The processor may be capable of being programmed to perform one or more operations or processes described elsewhere herein. A memory may include volatile and/or nonvolatile memory. For example, the memory may include random access memory (RAM), read only memory (ROM), a hard disk drive, and/or another type of memory (e.g., a flash memory, a magnetic memory, and/or an optical memory). The memory may be a non-transitory computer-readable medium. The memory may store information, one or more instructions, and/or software (e.g., one or more software applications) related to the operation of the controller 180. The controller 180 may perform one or more operations described herein. As described herein, the controller 180 is a component of the machine 100.

The controller 180 may receive, from the sensor 170, sensor data indicating a measurement of the property of the fluid 25 used in the bearing 31B. For example, the controller 180 may receive the sensor data including a temperature of the fluid 25, a pressure of the fluid 25, etc. In some examples, the controller 180 may receive the sensor data continuously or at specified (e.g., periodic) intervals.

The controller 180 may determine a difference between the measurement and a baseline value for the property of the fluid 25. The baseline value may be a reference value that represents normal operating conditions for the bearing 31B. In some examples, the controller 180 may compare the sensor data with a stored baseline value. In other examples, the controller 180 may determine the baseline value based on historical measurements of the property. For example, the controller 180 may receive historical measurement data that indicates the property (e.g., a fluid pressure, a fluid temperature, etc.) during normal operations of the machine 100 (e.g., which may correspond to an initial use of the machine 100). The controller 180 may update and/or adjust the baseline value based on trends in the measured data, operating conditions of the machine 100, etc. The controller 180 may use the difference to determine whether the measured property deviates from an expected range, indicating a potential issue with the bearing 31B.

The controller 180 may determine whether the difference satisfies a threshold. For example, the controller 180 may compare the calculated difference between the measurement and the baseline value to a threshold. The threshold may be set based on empirical data, manufacturer specifications, learned operating conditions, historical data, etc. In response to the difference exceeding the threshold, the controller 180 may classify the condition as abnormal, indicating a faulty condition (e.g., potential wear, fluid degradation, bearing failures, etc.). In some cases, the threshold may be adjusted over time based on usage patterns of the machine 100, environmental factors, etc. to improve diagnostic accuracy. For example, as the machine 100 ages, the threshold may be adjusted to compensate for wear or other degradation to the machine 100.

In some examples, the controller 180 may determine a compensation for at least one of the difference or the threshold to account for current operating conditions of the machine 100. The compensation may be based on at least one of an operating speed of the pump 150, a rotational speed of the bearings 21B, 22B, 23B (or of the rotatable journal 320), a fluid viscosity of the fluid 25, a fluid pressure of the fluid 25, a fluid temperature of the fluid 25, a fluid type, an oil type, a drive load (e.g., a torque that is either measured or calculated), or other factors that affect the difference or the threshold. The controller 180 may adjust the difference and/or the threshold using the compensation. For example, when the operating speed of the bearings 21B, 22B, 23B (or of the rotatable journal 320) increases, the controller 180 may adjust the threshold to account for expected variations in the measured property due to normal operating conditions. When the fluid viscosity changes due to, for example, temperature fluctuations, the controller 180 may compensate for the effect of viscosity on pressure measurements. This adaptive adjustment can help reduce false positives and ensure that fault indications are triggered when necessary.

The controller 180 may output an indication that the bearing 31B is faulty based on determining that the difference satisfies the threshold. In some examples, the controller 180 may transmit the indication to an operator interface (e.g., of operator station 128), a maintenance system, a user device (e.g., a smartphone or tablet), a remote monitoring system, etc. The indication may include diagnostic information such as the measured property value, the baseline value, the calculated difference, the threshold that is exceeded, the faulty condition type, etc. In some examples, the controller 180 may generate alerts in different formats, such as visual warnings on a display, audible alarms, or electronic notifications sent to a fleet management system, allowing for timely maintenance actions.

In some examples, the controller 180 may determine whether the difference satisfies each of a plurality of thresholds (e.g., a first threshold, a second threshold, etc.). For example, the first threshold may correspond to an early indication of wear, while the second threshold may correspond to a failure condition. For example, the second threshold my be greater than the first threshold. The controller 180 may output a first indication in response to determining that the difference satisfies the first threshold but not the second threshold, thereby providing an alert that the bearing 31B is experiencing wear. The controller 180 may output a second indication in response to the difference satisfying the first threshold and the second threshold, indicating that the bearing 31B has reached a failure condition.

In some examples, the controller 180 may adjust one or more operating parameters of the machine 100 in response to determining that the bearing 31B is faulty. The controller 180 may transmit a control signal to one or more elements of the machine 100 to control and/or adjust the one or more parameters of the machine 100. For example, the controller 180 may transmit the control signal that includes an instruction to increase or decrease the one or more operating parameters by a particular amount, to the prime mover 110, the hydraulic pump 150, or any other system that can control the machine 100 or a component thereof. As a non-limiting example, the controller 180 may cause adjustments, such as increasing an engine speed to maintain the hydraulic performance, elevating a cooling fan speed to manage temperature, reducing a pump load to reduce a stress on the bearing 31B, limiting a steering pump power to prevent excessive wear, etc., thereby mitigating the impact of the faulty bearing. These adjustments may help sustain operations of the machine 100 while preventing further damage until maintenance can be performed.

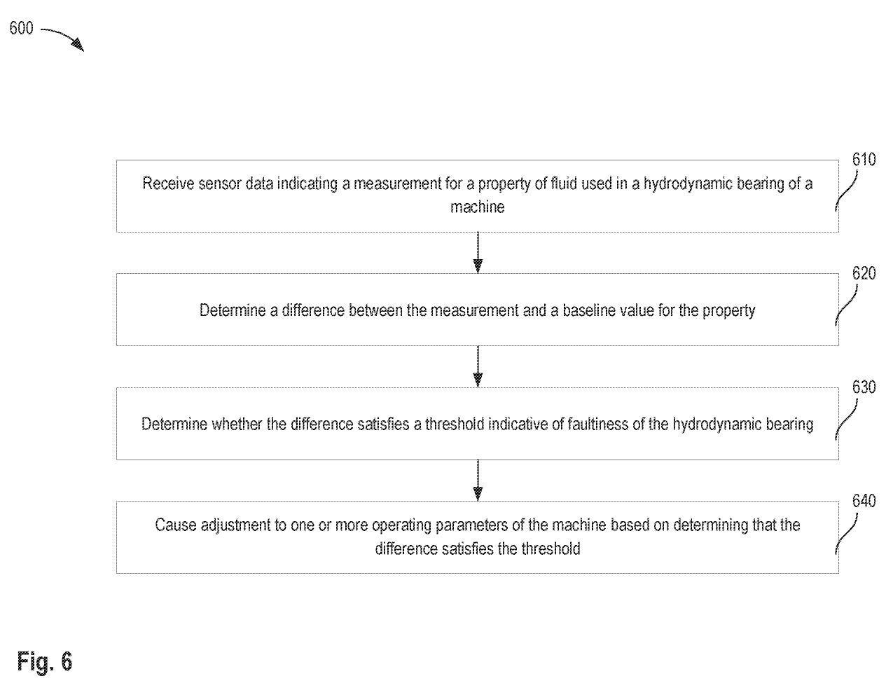

FIG. 6 is a flowchart of an example method 600. One or more steps of the method 600 may be performed by one or more controllers (e.g., the controller 180). Additionally, or alternatively, one or more steps of the method 600 may be performed by another device or a group of devices separate from or including the controller(s), such as another device or component that is internal or external to the machine 100.

At step 610, the method 600 may include receiving (e.g., by the controller 180) sensor data indicating a measurement for a property of fluid (e.g., the fluid 25) used in a hydrodynamic bearing (e.g., the bearing 31B) of a machine (e.g., the machine 100). For example, the method 600 may include receiving the sensor data indicating a temperature or a pressure of the fluid.

At step 620, the method 600 may include determining (e.g., by the controller 180) a difference between the measurement and a baseline value for the property. In some examples, the method 600 may include determining (e.g., by the controller 180) the baseline value based on historical measurements (e.g., of a fluid temperature, a fluid pressure, etc.).

At step 630, the method 600 may include determining (e.g., by the controller 180) whether the difference satisfies a threshold indicative of faultiness of the hydrodynamic bearing. In some examples, the method 600 may include determining (e.g., by the controller 180) a compensation for at least one of the difference or the threshold, and adjusting the at least one of the difference or the threshold using the compensation. In some examples, the method 600 may include determining (e.g., by the controller 180) whether the difference satisfies a first threshold and satisfies a second threshold. The method 600 may include outputting a first indication in response to satisfying the first threshold but not the second threshold. The method 600 may include outputting a second indication in response to satisfying the first threshold and the second threshold.

At step 640, the method 600 may include causing (e.g., by the controller 180) adjustment to one or more operating parameters of the machine based on determining that the difference satisfies the threshold. For example, the method 600 may include causing the adjustment to at least one of: an engine speed of the machine, a cooling fan speed, a pump load, etc. In some examples, the method 600 may include outputting (e.g., by the controller 180), based on determining that the difference satisfies the threshold, an indication of the faultiness of hydrodynamic bearing.

Although FIG. 6 shows example steps of the method 600, in some implementations, the method 600 may include additional steps, fewer steps, different steps, or differently arranged steps than those depicted in FIG. 6. Additionally, or alternatively, two or more of the steps of the method 600 may be performed in parallel.

### INDUSTRIAL APPLICABILITY

The monitoring system 130 described herein may be used with any system that includes a bearing on which a load is applicable (e.g., a hydrodynamic bearing in a hydraulic pump, an electrical generator, an alternator, a water pump, an air conditioning compressor, etc.). For example, the monitoring system 130 may be used with the gear train 200 (e.g., for the hydraulic pump 150) that includes the bearing 31B. The hydraulic pump 150 may be used to control steering, implements, powertrain components, or other components in machines involved in earthmoving, mining, paving, or other industries. In such hydraulic systems, bearings within the gear train are subjected to continuous wear and potential failure due to variations in operating conditions, fluid properties, and mechanical stresses. Traditional systems may not provide an efficient detection of bearing degradation, leading to unexpected failures, increased maintenance costs, and reduced operational efficiency.

However, the monitoring system 130 described herein is useful for detecting bearing wear and potential failure by monitoring a property of the fluid 25, such as a fluid pressure or a fluid temperature, within the bearing 31B. In particular, the monitoring system 130 may determine deviations from baseline values, apply compensations based on operating conditions, and determine whether detected changes meet wear or failure thresholds. In this configuration, the monitoring system 130 enables early detection of bearing degradation, reducing the likelihood of unexpected failures. Accordingly, the monitoring system 130 may enhance the reliability of hydraulic systems, optimize maintenance schedules, and improve the overall efficiency and lifespan of machinery utilizing hydrodynamic bearings. Furthermore, in response to a detected fault, the monitoring system 130 may adjust machine operating parameters, such as an engine speed or a pump load, to mitigate a potential damage and sustain the operational performance of the machine 100.

The foregoing describes only some embodiments, and alterations, modifications, additions and/or changes can be made thereto without departing from the scope and spirit of the disclosed embodiments, the embodiments being illustrative and not restrictive. Furthermore, implementations are not limited to the disclosed embodiments, and may cover various modifications and equivalent arrangements included within the spirit and scope of the disclosed embodiments. Also, the various embodiments described above may be implemented in conjunction with other embodiments, for example, aspects of one embodiment may be combined with aspects of another embodiment to realize yet other embodiments. Further, each independent feature or component of any given assembly or process may constitute an additional embodiment. As used herein, the singular forms of “a,” “an,” and “the” include plural referents unless the context clearly dictates otherwise. In addition, as used herein, the term “or” means “and/or” unless the context clearly dictates otherwise.

When “a controller” or “one or more controllers” is described or claimed (within a single claim or across multiple claims) as performing multiple operations or being configured to perform multiple operations, unless described or claimed otherwise (e.g., via the use of “first controller” and “second controller” or other language that differentiates controllers) this language is intended to cover a single controller performing or being configured to perform all of the operations, a group of controllers collectively performing or being configured to perform all of the operations, a first controller performing or being configured to perform a first operation and a second controller performing or being configured to perform a second operation, or any combination of controllers performing or being configured to perform the operations.

Further, spatially relative terms, such as “upper,” “lower,” “top,” “bottom,” “left,” “right,” etc., may be used herein to describe one element or feature’s relationship to another element(s) or feature(s) as illustrated in the figures. The spatially relative terms are intended to encompass different orientations in use or operation in addition to the orientation(s) depicted in the figures. Accordingly, the spatially relative terms may be interpreted in a corresponding manner to rotations of the orientation(s) depicted in the figures.

What is claimed is:

1. A monitoring system, comprising:
a sensor configured to measure, via a measurement passage, a property of fluid used in a hydrodynamic bearing disposed in a housing,
wherein the sensor is coupled to a measurement port accessible from an exterior of the housing, and the measurement passage fluidly connects a bearing liner of the hydrodynamic bearing and the measurement port; and
a controller configured to:
receive, from the sensor, sensor data indicating a measurement of the property;
determine a difference between the measurement and a baseline value for the property;
determine whether the difference satisfies a threshold; and
output an indication that the hydrodynamic bearing is faulty based on determining that the difference satisfies the threshold.

2. The monitoring system of claim 1, wherein the property is a pressure or a temperature of the fluid.

3. The monitoring system of claim 1, wherein the controller is further configured to:
determine a compensation for at least one of the difference or the threshold; and
adjust the at least one of the difference or the threshold using the compensation.

4. The monitoring system of claim 3, wherein the compensation is based on at least one of: a rotational speed of the hydrodynamic bearing, a fluid viscosity of the fluid, a fluid pressure of the fluid, or a fluid temperature of the fluid.

5. The monitoring system of claim 1, wherein the controller is further configured to adjust one or more operating parameters of a machine in response to a faultiness of the hydrodynamic bearing.

6. The monitoring system of claim 1, wherein the sensor includes a temperature probe extending into the measurement passage.

7. The monitoring system of claim 1, wherein the controller is further configured to determine the baseline value based on historical measurements of the property.

8. The monitoring system of claim 1, wherein the hydrodynamic bearing is one of a plurality of bearings in the housing, and is a furthest, of the plurality of bearings, from a fluid supply input.

9. The monitoring system of claim 1, further comprising a fluid supply passage in the housing configured to supply the fluid to the hydrodynamic bearing.

10. The monitoring system of claim 1, wherein, the controller, to determine whether the difference satisfies the threshold, is configured to:
determine whether the difference satisfies a first threshold and satisfies a second threshold; and
output a first indication in response to the difference satisfying the first threshold but not the second threshold, or a second indication in response to the difference satisfying the first threshold and the second threshold.

11. A method, comprising:
receiving, by a controller, sensor data indicating a measurement for a property of fluid used in a hydrodynamic bearing of a machine,
wherein the property is a temperature or a pressure of the fluid;
determining a difference between the measurement and a baseline value for the property;
determining whether the difference satisfies a threshold indicative of faultiness of the hydrodynamic bearing; and
causing adjustment to one or more operating parameters of the machine based on determining that the difference satisfies the threshold.

12. The method of claim 11, further comprising:
determining a compensation for at least one of the difference or the threshold; and
adjusting the at least one of the difference or the threshold using the compensation.

13. The method of claim 11, wherein the one or more operating parameters include at least one of: an engine speed of the machine, a cooling fan speed, or a pump load.

14. The method of claim 11, further comprising outputting, based on determining that the difference satisfies the threshold, an indication of the faultiness of the hydrodynamic bearing.

15. The method of claim 11, further comprising determining the baseline value based on historical measurements.

16. The method of claim 11, further comprising:
determining whether the difference satisfies a first threshold and satisfies a second threshold; and
outputting a first indication in response to satisfying the first threshold but not the second threshold, or a second indication in response to satisfying the first threshold and the second threshold.

17. A work machine, comprising:
a prime mover;
a gear train for a hydraulic pump, comprising:
a housing;
a rotatable journal, disposed in the housing, operatively coupled to the prime mover;
a hydrodynamic bearing comprising a bearing liner between the housing and the rotatable journal; and
a measurement port, accessible from an exterior of the housing, that is fluidly connected to the bearing liner via a measurement passage that extends through the housing; and
a monitoring system, comprising:
a sensor, coupled to the measurement port, configured to measure, via the measurement passage, a property of fluid used in the hydrodynamic bearing; and
a controller configured to:
receive, from the sensor, sensor data indicating a measurement of the property;
determine a difference between the measurement and a baseline value for the property; and
output an indication that the hydrodynamic bearing is faulty based on determining that the difference satisfies a threshold.

18. The work machine of claim 17, wherein the sensor includes a temperature probe extending into the measurement passage.

19. The work machine of claim 17, wherein the hydrodynamic bearing is one of a plurality of bearings in the housing, and is furthest from a fluid supply input.

20. The work machine of claim 17, wherein the hydraulic pump further comprises a fluid supply passage configured to supply the fluid to the hydrodynamic bearing.
